(19) United States
(12) Patent Application Publication
(10) Pub. No.: US 2007/0025549 A1
(43) Pub. Date: Feb. 1, 2007

(54) Telephone interface circuit

(76) Inventor: Yoshinobu Fujiwara, Tokyo (JP)

Correspondence Address: INTELLECTUAL PROPERTY / TECHNOLOGY LAW, PO BOX 14329, RESEARCH TRIANGLE PARK, NC, 27709, US

(21) Appl. No.: 11/175,944

(22) Filed: Jul. 6, 2005

(51) Int. Cl. H04M 1/00; H04M 9/00

(52) U.S. Cl. 379/412

(57) ABSTRACT

A telephone interface circuit includes a speech circuit, a hook switch that opens and closes connection between a subscriber line and the speech circuit, an overvoltage detector that detects overvoltage input to the subscriber line, and a control circuit that controls the hook switch when overvoltage is detected by the overvoltage detector so as to open the connection between the subscriber line and the speech circuit.

### BACKGROUND

The present invention relates to an interface circuit for protecting a telephone from transient overvoltage such as surge voltage, and successively incoming overcurrents due to, for example, fault contact between a commercial power line and subscriber line.

In overhead subscriber lines, there is a possibility of transient propagation of induced lightning caused by lightning strike or of successive flow of overcurrent over a fairly long period due to fault contact with commercial power lines (lightning surge). For this reason a protective circuit is provided in the interface circuit of the telephone and the subscriber line. Known measures for preventing lightning surges include a layout in which for example a varistor element is connected between two subscriber lines or a layout in which a varistor element is connected between the subscriber line and earth. If transient surge voltage exceeding the varistor voltage is applied to the subscriber line, the varistor element shifts into conductive mode, thereby absorbing the surge voltage and protecting the speech circuit within the telephone.

A layout is also known in which for example a PTC thermistor (positive temperature coefficient thermistor) is inserted in the interface of the subscriber line and the telephone as a countermeasure against generation of heat in the telephone or the telephone catching fire due to fault contact between the subscriber line and a commercial power line. If overcurrents flow successively into the PTC thermistor over a certain time, the input impedance of the interface is increased by the rise in temperature of this element, thereby enabling inflow of overcurrent into the interior of the telephone to be suppressed.

### SUMMARY

However, in a telephone interface circuit in which a semiconductor element is employed for opening/closing the connection between the speech circuit and the subscriber line, in order to avoid the secondary breakdown phenomenon that is peculiar to semiconductor elements, it was necessary to strictly observe the current and voltage ratings and use of a costly “SIDAC” (Registered Trademark) protective circuit was indispensable.

The problem of the present invention was therefore to provide an inexpensive telephone interface circuit, while maintaining reliability of the interface circuit, in order to protect the telephone from overcurrent and overvoltage.

In order to solve the above problem, a telephone interface circuit according to the present invention includes a speech circuit, a hook switch that opens and closes the connection between the subscriber line and the speech circuit, an overvoltage detector that detects overvoltage that is input to the subscriber line, and a control circuit that controls the hook switch when overvoltage is detected by the overvoltage detector, so as to open the connection between the subscriber line and the speech circuit,

By additionally providing the hook switch with an overvoltage cut-off function (or loop current cut-off function), the telephone can be protected from overvoltage and overcurrent. Manufacturing costs can also be lowered by employing an inexpensive transistor element of low collector loss as the hook switch.

As the control circuit, a circuit is desirable including the function of closing the connection between the subscriber line and the speech circuit after a lapse of a predetermined time from opening of the connection between the subscriber line and the speech circuit. The telephone interface circuit can thus be restored to normal after the overvoltage has disappeared from the subscriber line.

### DESCRIPTION OF DRAWINGS

FIG. 1 is a view of the circuit layout of a telephone interface circuit according to embodiment 1;

FIG. 2 is a view of the circuit layout of a telephone interface circuit according to embodiment 1:

FIG. 3 is a view of the circuit layout of a telephone interface circuit according to embodiment 2;

FIG. 4 is a view of the circuit layout of a telephone interface circuit according to embodiment 2;

FIG. 5 is a view of the circuit layout of a telephone interface circuit according to embodiment 2;

FIG. 6 is a graph showing the relationship between loop current and voltage; and

FIG. 7 is a graph showing the relationship between loop current and time,

### DETAILED DESCRIPTION

(Embodiment 1)

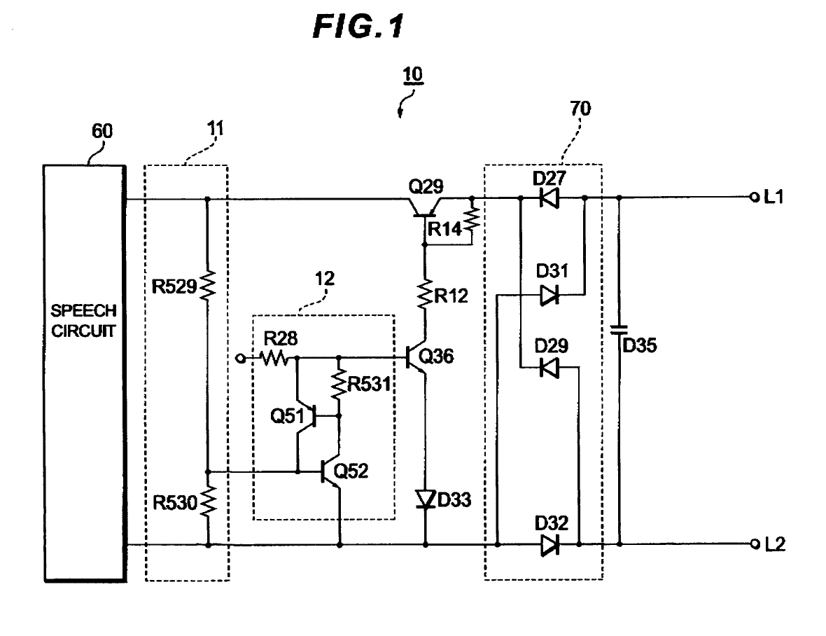

FIG. 1 shows the circuit layout of a telephone interface circuit 10 according to embodiment 1 of the present invention.

The telephone interface circuit 10 controls interfacing between the speech circuit 60 and subscriber lines L1, L2. The telephone interface circuit 10 mainly includes a varistor element D35, diode bridge 70, hook switch Q29, voltage divider 11 and SCR (Silicon Controlled Rectifier) circuit 12.

The varistor element D35 absorbs overvoltage (for example high voltage of about 270 V or more) between the subscriber lines L1 and L2.

The diode bridge 70 rectifies the signal flowing through the subscriber lines L1 and L2 and supplies this to the speech circuit 60. The diode bridge 70 includes four diode elements D27, D31, D29 and D32.

The hook switch Q29 is turned on during “off hook” and, on call origination, transmits a dial pulse signal in response to the dialing input. Also, the hook switch Q29 turns off during “on hook”, isolating the speech circuit 60 from the subscriber lines L1, L2. Also, during “off hook”, when overvoltage is applied to the subscriber lines L1, L2, the hook switch Q29 shifts from the turned on condition to the turned off condition, isolating the speech circuit 60 from the subscriber lines L1, L2 (the details of this will be described later). The hook switch Q36 is a switching element including a PNP transistor.

The voltage divider 11 is a feedback circuit that divides the voltage across the subscriber lines L1, L2 by R530/(R529+R530) and feeds back the divided voltage to the gate terminal of the SCR circuit 12. The voltage divider 11 includes series-connected resistors R529 and R530. The voltage divider 11 functions as an overvoltage detector.

The SCR circuit 12 is a thyristor including transistors Q51 and Q52. The transistor Q51 is a PNP transistor and the transistor Q52 is an NPN transistor. The SCR circuit 12 functions as a control circuit that opens and closes the connection of the subscriber lines L1, L2 with the speech circuit 60 by opening/closing control of the hook switch Q29 when overvoltage is detected in the voltage divider 11. A control circuit provided with such a function may also be implemented by means of for example a microcomputer.

The emitter terminal of the hook switch Q29 is connected with the subscriber line L1. A resistor R14 is connected between the base terminal and the emitter terminal of the hook switch Q29. The base terminal of the hook switch Q29 is connected with the collector terminal of the transistor Q36 through a resistor R12. The anode terminal of the SCR circuit 12 is connected with the base terminal of the transistor Q36 and the cathode terminal of the SCR circuit 12 is connected with the emitter terminal of the transistor Q36 through a diode D33. The gate terminal of the SCR circuit 12 makes a branch connection with the voltage divider 11.

In the above construction, during “on hook”, the base potential of the transistor Q36 is maintained at low potential and the transistor Q36 is thereby maintained in a turned off condition. Also, the base potential of the hook switch Q29 is maintained at high potential, so the hook switch Q29 is in a turned off condition.

In contrast, in the case of “off hook”, the base potential of the transistor Q36 is maintained at high potential and the transistor Q36 is thereby in a turned off condition. Also, the base potential of the hook switch Q29 is maintained at low potential, so the hook switch Q29 is in a turned on condition. The signal flowing through the subscriber lines L1 and L2 is rectified by the diode bridge 70 and then passes through the hook switch Q29, whence it is supplied to the speech circuit 60. The loop current thus flows in the telephone interface circuit 10.

The operation that takes place if overvoltage is applied to the subscriber lines L1, L2 in the off hook condition will now be described. When overvoltage is applied to the subscriber lines L1, L2, the divided potential of the voltage divider 11 exceeds the base potential (about 0.6 V) of the transistor Q52, causing a trigger current to flow to the gate terminal of the SCR circuit 12. This causes gate firing of the SCR circuit 12, which is in a forward blocking condition, with the result that current starts to flow between the anode terminal and the cathode terminal. The collector potential of the transistor Q52 thereby starts to drop, so the collector potential of the transistor Q51 also starts to drop. When this happens, the base potential of the transistor Q36 drops, and the transistor Q36 is turned off. The hook switch Q29 is thereby also turned off, and inflow of the overvoltage to the speech circuit 60 is thereby completely cut off. The diode D33 is a level shifter to ensure reliable turn-off of the transistor Q36 on gate firing of the SCR circuit 12.

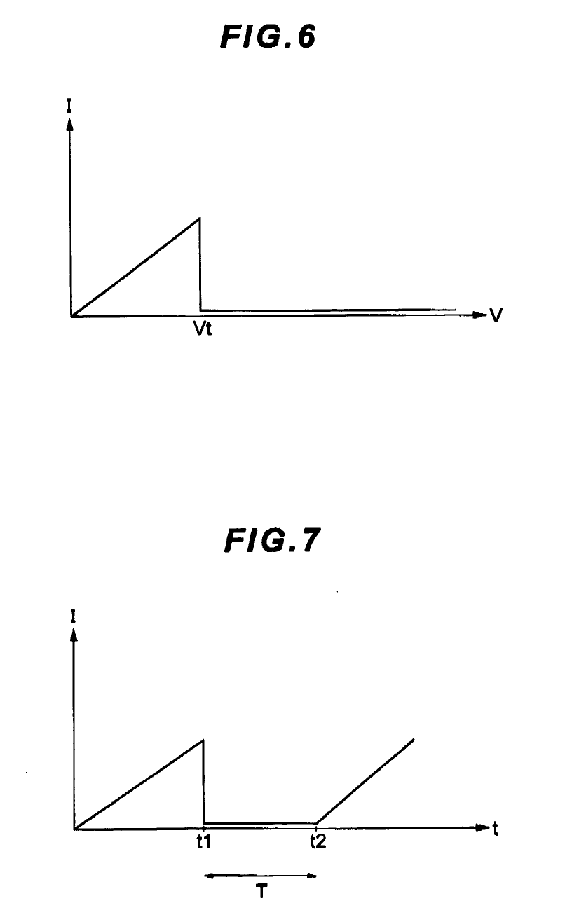

FIG. 6 shows the relationship between the voltage V across the subscriber lines L1 and L2 and the loop current I. If the voltage V exceeds a threshold voltage Vt, the gate of the SCR circuit 12 fires, and the hook switch Q29 is thereby turned off. In this way, the loop current I is instantaneously completely cut off, becoming zero.

Thus, when overvoltage is supplied to the subscriber lines L1, L2, inflow of overvoltage to the speech circuit 60 can be completely cut off by turning off the hook switch Q29.

Also, although, conventionally, in view of the possibility of abnormal currents such as lightning surges, a hook switch Q29 having a maximum collector loss of the order of 1 to 2 W was employed, in this embodiment, in the ordinary condition of use, the collector/emitter voltage of the hook switch 29 is 1 V or less and the loop current is 0.1 A or less, so a hook switch with a maximum collector loss of about 0.1 W is fully satisfactory. That is, a less expensive transistor element can be employed as the hook switch Q29 than in the prior art.

Circuit design is also facilitated by the fact that it is possible to adjust the trigger voltage of the SCR circuit 12 by adjusting the resistance division ratio of the voltage divider 11.

Also, since the SCR circuit 12 has a rapid speed of response (of the order of μs), it can protect the speech circuit 60 effectively not only against continuous overvoltage but also against transient overvoltage.

It should be noted that it is desirable to arrange the voltage divider 11 downstream of the hook switch Q29. This is because there is a risk that, if the voltage divider 11 is arranged upstream of the hook switch Q29, when a bell signal (signal for example of the order of 200 V) arrives at the subscriber lines L1, L2, the gate of the SCR circuit 12 will be fired, causing the hook switch Q29 to be turned off,

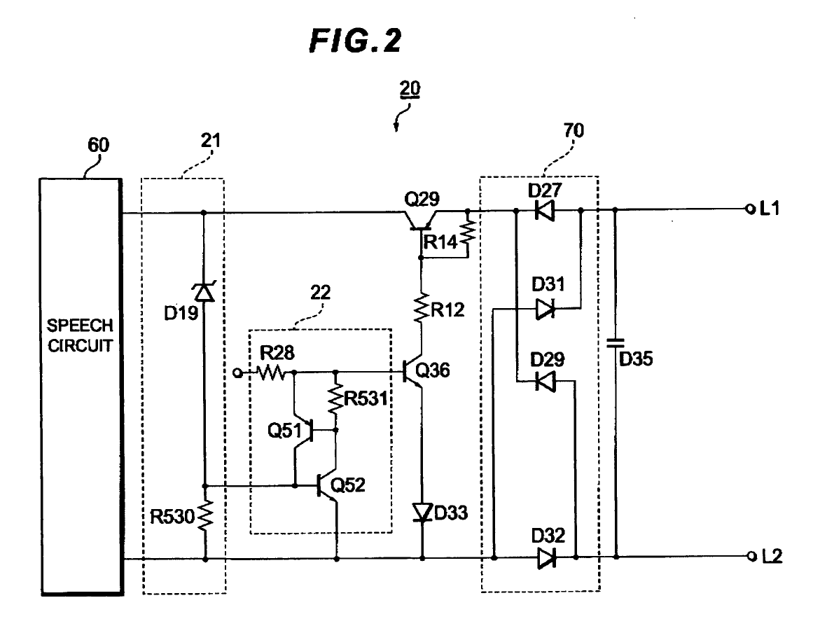

FIG. 2 shows the circuit layout of a telephone interface circuit 20.

As shown in this Figure, the voltage divider 21 is of a construction using a Zener diode D19 instead of the resistor R529 mentioned above. The layout of the telephone interface circuit 20 is the same as the layout of the telephone interface circuit 10 described above.

(Embodiment 2)

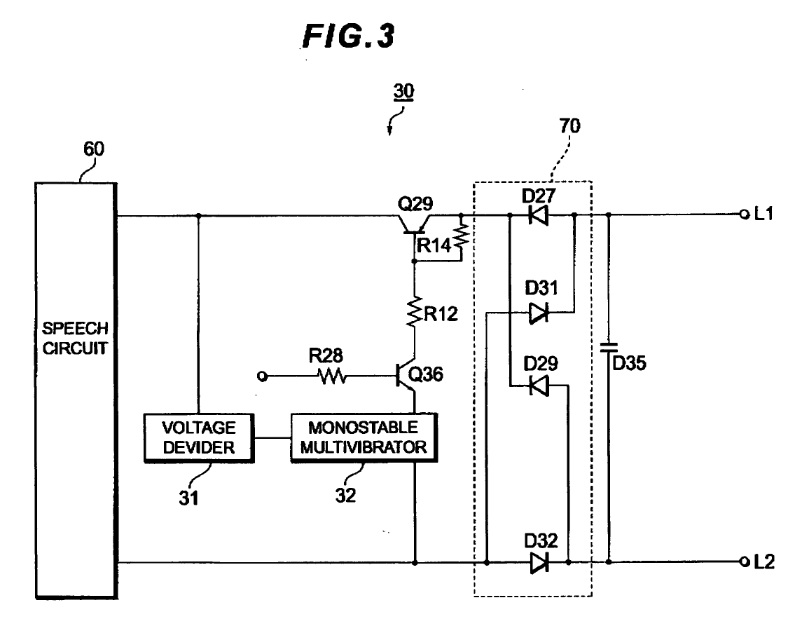

FIG. 3 shows the circuit layout of a telephone interface circuit 30 according to embodiment 2 of the present invention.

The telephone interface circuit 30 mainly includes a varistor element D35, diode bridge 70, hook switch Q29, voltage divider 31 and monostable multi-vibrator circuit 32.

The voltage divider 31 is a feedback circuit that feeds back to the monostable multi-vibrator 32 the divided voltage obtained by dividing the voltage across the subscriber lines L1, L2. When overvoltage flows into the subscriber lines L1, L2, trigger voltage (divided voltage obtained by dividing the overvoltage) is supplied to is the monostable multi-vibrator 32 from the voltage divider 31. When this happens, the monostable multi-vibrator 32, which was in a stable condition, is shifted into the metastable condition. The emitter potential of the transistor Q36 of the multi-vibrator 32 which is now in a metastable condition is thereby pulled up. When this happens, the base potential of the transistor Q36 is relatively lowered and the transistor Q36 is thereby turned off. Concomitantly, the hook switch Q29 is also turned off, and inflow of overvoltage to the speech circuit 60 is thereby totally cut off.

After the lapse of the time constant T, the monostable multi-vibrator 32 shifts from the metastable condition to the stable condition and the emitter potential of the transistor Q36 is thereby pulled down. When this happens, the base potential of the transistor Q36 is thereby relatively raised, with the result that the transistor Q36 is turned on. Concomitantly, the hook switch Q29 is also turned on and the loop current starts to flow in the telephone interface circuit 30.

FIG. 7 shows the relationship between the loop current flowing through the telephone interface circuit 30 and the time t. When, at the time point t1, the voltage across the subscriber lines L1, L2 exceeds the prescribed threshold voltage, trigger voltage is input from the voltage divider 31 to the monostable multi-vibrator 32, causing the hook switch Q29 to turn off. The loop current I is thereby instantaneously totally cut off, becoming zero. At the time point t2 where the time constant T has elapsed after the time point t1, the monostable multi-vibrator 32 shifts from the metastable condition to the stable condition. When this happens, as described above, the hook switch Q29 is turned on and the loop current I again starts to flow.

In this way, by utilizing the self restoring function of the monostable multi-vibrator 32, when the circuit is restored to normal after forcible cut-off of the loop current, the hook switch Q29 can again be turned on, so telephone service becomes possible. If, due to fault contact between the commercial power line and the subscriber line, the transient voltage continues to flow for a long time, even if the hook switch Q29 is turned on by the self restoring function of the monostable multi-vibrator 32, the hook switch Q29 will again be turned off, cutting off the loop current, due to input of trigger voltage to the monostable multi-vibrator 32 immediately thereafter.

The monostable multi-vibrator 32 functions as a control circuit that opens/closes the connection between the subscriber lines L1, L2 and the speech circuit 60 by opening/closing control of the hook switch Q29 when overvoltage is detected by the voltage divider 31. A control circuit having such a function can be implemented for example by a microcomputer.

Preferably the time constant T of the monostable multi-vibrator 32 should be set to a time that is longer than the period (for example 1 ms) of a typical lightning surge voltage and that is shorter than the time taken by the telephone service provider to recognize circuit disconnection (for example the “catch phone” time (about 300 ms)). By setting the time constant T in this way, not only is it possible to protect the speech circuit 60 from transient overvoltage such as lightning surges but is also possible to protect the speech circuit 60 from overvoltage flowing into the subscriber lines over a long period.

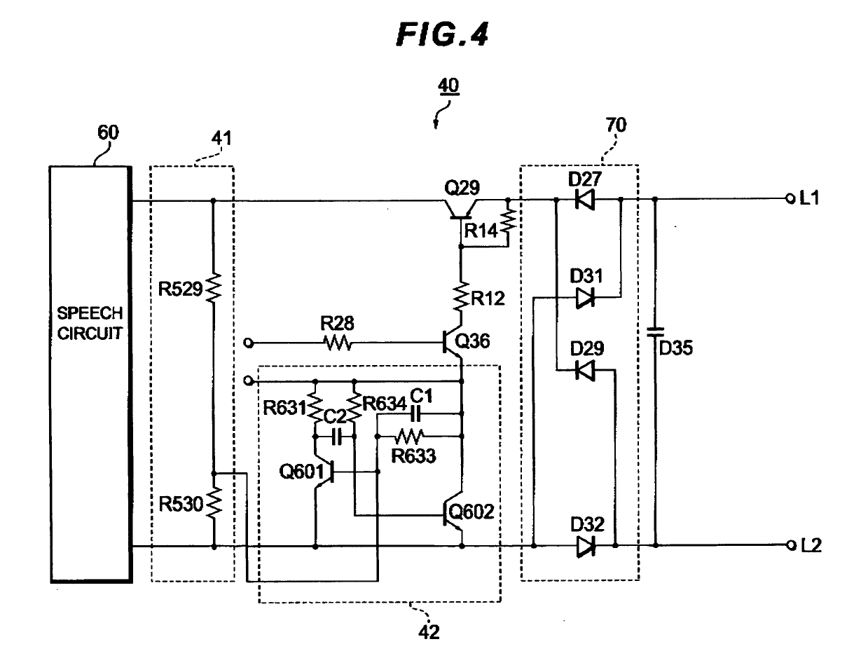

FIG. 4 shows the circuit layout of a telephone interface circuit 40.

As shown in this Figure, a voltage divider 41 includes resistors R529 and R530 connected in series. A monostable multi-vibrator 42 includes transistors Q601, Q602, resistors R631, R633, R634 and capacitors C1, C2.

When trigger voltage is input from the voltage divider 41 to the monostable multi-vibrator 42, the collector voltage of the transistor Q602 is raised. When this happens, the base potential of the transistor Q36 is relatively lowered, so the transistor Q36 is turned off. Concomitantly, the hook switch Q29 is also turned off. After this, after a lapse of the time constant T, the monostable multi-vibrator 42 shifts from the metastable condition to the stable condition, causing the collector potential of the transistor Q602 to drop. When this happens, the base potential of the transistor Q36 is relatively raised, causing the transistor Q36 to turn on. Concomitantly, the hook switch Q29 is also turned on, causing the loop current to start to flow in the telephone interface circuit 40.

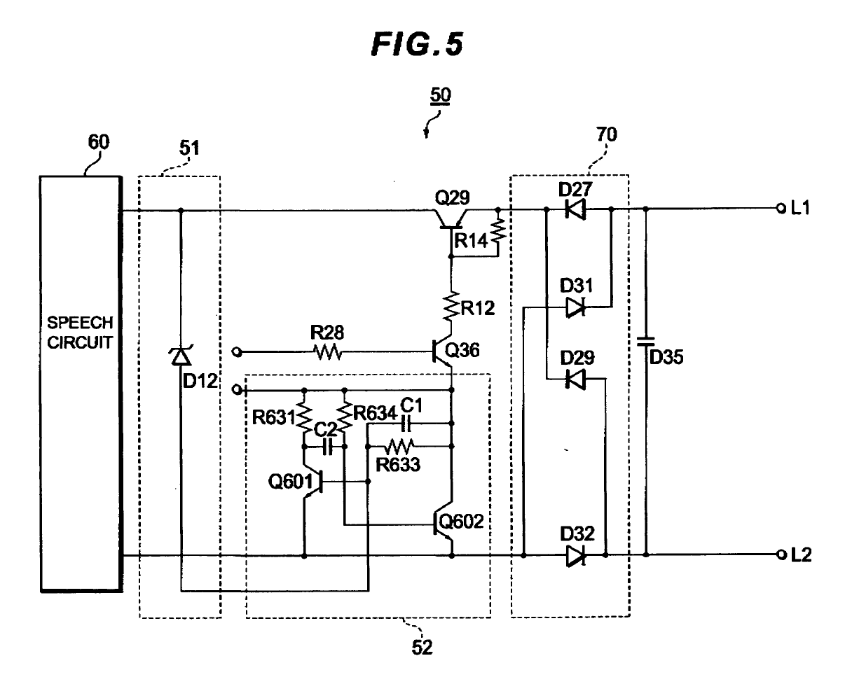

FIG. 5 shows the circuit layout of a telephone interface circuit 50.

As shown in this Figure, a voltage divider 51 includes a Zener diode D12. A monostable multi-vibrator 52 includes the same layout as the monostable multi-vibrator 42.

We claim:

1. A telephone interface circuit comprising:
a speech circuit;
a hook switch opening and closing a connection between a subscriber line and said speech circuit;
an overvoltage detector detecting overvoltage that is input to said subscriber line; and
a control circuit controlling said hook switch when the overvoltage is detected by said overvoltage detector, so as to open the connection between said subscriber line and said speech circuit.

2. The telephone interface circuit according to claim 1, wherein said control circuit is an SCR circuit that turns off said hook switch in response to trigger voltage output from said overvoltage detector.

3. The telephone interface circuit according to claim 1, wherein said control circuit closes the connection between said subscriber line and said speech circuit after a lapse of a predetermined time from opening of the connection between said subscriber line and said speech circuit.

4. The telephone interface circuit according to claim 3, wherein said control circuit is a monostable multi-vibrator that turns off said hook switch in response to trigger voltage output from said overvoltage detector.

5. The telephone interface circuit according to claim 1, wherein said overvoltage detector is provided between said speech circuit and said hook switch.

6. The telephone interface circuit according to claim 1, wherein said hook switch is a transistor element.
